(19) United States
(12) Patent Application Publication
(10) Pub. No.: US 2014/0016317 A1
(43) Pub. Date: Jan. 16, 2014

(54) LANDING LIGHT

(71) Applicant: Stephen P. Adams, Mesa, AZ (US)

(72) Inventor: Stephen P. Adams, Mesa, AZ (US)

(73) Assignee: JST PERFORMANCE, INC. DBA RIGID INDUSTRIES, MESA, AZ (US)

(21) Appl. No.: 13/550,109

(22) Filed: Jul. 16, 2012

(51) Int. Cl. F21V 5/04; F21V 21/00; F21V 17/00; F21V 13/04

(52) U.S. Cl. 362/245; 362/235; 362/382; 362/335; 29/428

(57) ABSTRACT

A light source having curved convex forward and rearward facing surfaces having a one-piece fixture body with a compartment including at least one light source positioned to direct light from the compartment in a forward direction towards a removable lens and a transparent media that removably couples to the compartment and secures the removable lens positioned between the at least one light source and the transparent media.

### BACKGROUND OF THE INVENTION

1. Field of the Invention

The present invention relates to light fixtures with structure to promote cooling and reduce mass. The light fixture also relates to methods and components that permit altering the light distribution characteristics of light fixtures.

2. Discussion of the Prior Art

Light sources such as energized filament lighting and Light Emitting Diodes (LEDs) emit radiation in the forms of light and heat and excessive heating in a light fixture degrades the performance of the light source, reduces operating life, and damages active and passive electronics and electrical conductors. It follows that light fixtures have been developed to promote the dissipation of generated heat.

U.S. Pat. No. 7,954,981 illustrates a light fixture having cooling fins to dissipate generated heat. The cooling fins circumferentially traverse the barrel of a cylindrically shaped light fixture and have uniform dimensions. U.S. Pat. Pub. No. US 2009/0034261 A1 discloses a surface-mounted light fixture having uniform sized cooling fins that extend outward from a puck-like center enclosure. U.S. publication number: US 2011/0235330 A1 discloses a moving light fixture with cooling fins located on the outer portion of a head mounted on a yoke. U.S. Patent Pub. No. US 2010/0013366 A1 discloses a disc shaped light fixture with rear facing cooling fins and air gaps oriented substantially parallel to the forward light projection direction. U.S. Pat. No. 6,984,061 disclosed an infrared landing light with a flat protective external media. U.S. Pat. No. 5,997,159 illustrates a light fixture having a dome shaped lens with a dome base connected to a cylindrically shaped fixture body. The prior art does not disclose a light fixture having a structure with reduced mass, efficient cooling, and the ability to alter the light distribution characteristics of the light fixture.

### BRIEF DESCRIPTION OF THE DRAWINGS

FIG. 1 illustrates an exploded view of an embodiment having a lens system 2 removably coupled to a fixture body 1 and wherein the lens system comprises a transparent media 20 and a insertable lens 30, which insertable lens 30 permits alteration of the light distribution characteristics from at least one light source within a compartment 40 recessed within the fixture body 1;

FIG. 2 illustrates the lens system 2 of the embodiment and the receipt via one dimensional movement of the insertable lens 30 into contact with an edge on the rear surface of the transparent media 20;

FIG. 3 illustrates the transparent media 20 including the segmental dome shape, a boss 24 extending from the rear surface of the transparent media, and ridges increasing in height as the ridges progress towards the perimeter of the transparent media 20;

FIG. 4 illustrates an aperture 33 in the surface and center of the insertable lens 30 that receives the boss 24 from the transparent media 20, a surface of the lens 30 enabling diffusion of light from a light source 43 in the compartment 40, and standoffs 37 that position the lens 30 away from the at least one light source 43 in the compartment 40;

FIG. 5 illustrates an assembled view of the light figure showing the alignment of the transparent media ridges 29 with the end of the frame elements 14 distal to the perimeter 10;

FIG. 6 illustrates the measurements of the height (h_{R}) and diameter (d_{R}) of the frame comprised of the rearward facing curved convex surface, and the height (h_{F}) and diameter (dF) of the frame comprised of the forward facing curved convex surfaces;

FIG. 7 illustrates a side view of the fixture showing the perimeter 10 and sub-perimeter 11 of the light fixture and shows the relative thickness of the transparent media 20;

0 FIGS. 8 & 9 illustrates a side views of the light fixture showing grommets in apertures 45 for access into the compartment 40 and the frame elements 14;

FIG. 10 illustrates a back view of the light fixture and the swirling pattern of the frame elements 14;

FIG. 11 illustrates a perspective view of the light fixture and the apertures in the rear of the light fixture permitting access for electrical conductors into the compartment 40; and

FIG. 12 illustrates a front view of the light fixture with the insertable lens 30 removed.

### SUMMARY OF THE INVENTION

This summary is not exhaustive or indicative of every aspect or object of the invention.

Illustrative aspects and details will be discussed and described where and how they fit the purposes of describing and enabling the invention. This summary should not be deemed as limiting the scope of the description or the claims.

Aspects of the invention are embodied in an exemplary light fixture. The exemplary light fixture includes a fixture body having a compartment including at least one light source 43 positioned to direct light from the compartment in a forward direction. A transparent media removably couples to the compartment and a removable lens is positioned between the at least one light source 43 and the transparent media and deterred from movement by contact between the fixture body and the transparent media. The shape of the light fixture is composed by the transparent media, which has a forward surface comprising an upper portion of the curved convex surface, and a frame of ridges, or frame elements extending radially forward and having forward facing surfaces framing a lower portion of a the curved convex surface. The transparent media forward surface may have a plurality of ridges increasing in height proportionally to their distance from an apex of the curved convex surface and each of the plurality of ridges may align with one of the frame elements. The curved convex surface has a base diameter of between about 4.5 and 8.5 times the height of the curved convex surface and the two dimensional projection of the surface area of the transparent media is between about 4.4 and 8.1 times the surface area comprised of the two dimensional projection of the forward facing surfaces of the lower portion of the curved convex surface. The transparent media perimeter has an inner surface having a edge at the transparent media perimeter abutting the removable lens that deters movement of the removable lens relative to the transparent media. The exemplary light fixture may be equipped with a removable lens selected from group of diffusing lenses and light collimating lenses.

Several objects are fulfilled by the invention. For example, it is an object of the invention to provide alternate lighting characteristics for a light source 43. It is also an object of the invention to improve the aerodynamics of a light fixture, to reduce mass and promote cooling by directing air over frame elements comprised of ridges or fins that radiate from a compartment having a light source 43 therein.

### DESCRIPTION OF EMBODIMENTS

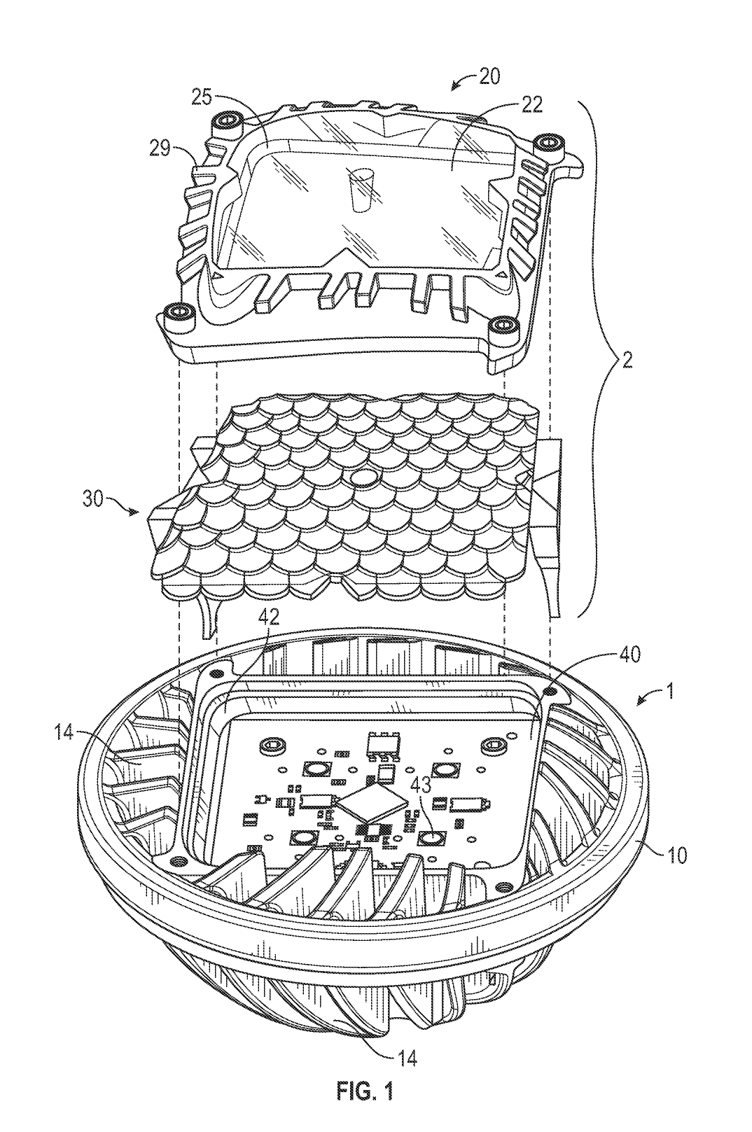

FIG. 1 illustrates an exemplary light fixture comprised of a fixture body 1 and a lens system 2. The lens system 2, which is removably coupled to the fixture body 1, comprises a protective transparent media 20 and an insertable or removable lens 30 that is positioned forward of at least one light source 43 in an electronics compartment 40 and permits alteration of the inherent lighting characteristics of the at least one light source 43. The fixture body 1 is preferably comprised of a sturdy lightweight metal such as aluminum or an equivalent and is a one-piece molded structure having the electronics compartment 40 recessed in the fixture body 1, with compartment access holes 45 located in or adjacent the back wall of the compartment 40 and accessible at the back of the fixture body 1. The electronics compartment 40 is recessed in the fixture body 1 behind the transparent media 20 and encloses from the sides and bottom the passive and active components and circuitry associated with at least one light source module. The at least one light source module is positioned within the compartment 40 to direct light substantially forward at the removable lens 30 and transparent media 20 and may include a distinct housing including a reflector or refractor or may be included on a circuit board with at least another light source 43 with a reflector or refractor positioned above and associated with each light source.

The forward facing surface of the light fixture includes the forward facing surface 22 of the transparent media 20 and the forward facing surface portion(s) of the fixture body 1. The forward facing surface of the light fixture comprises a curved convex shape such as a bulging, rounded, or substantially semi-spherical or semi-ellipsoid shape, with a forward facing apex located on the transparent media 20 and a base located on the fixture body and preferably at the portion of the fixture body including or comprising the fixture perimeter 10. The forward facing surface portion(s) of the fixture body 1 may comprise an unbroken smooth or textured surface but preferably comprises the forward facing surfaces or edges of a plurality of ribs, ridges, or frame elements 14 that span between the compartment 40 and fixture perimeter 10 with air gaps between the frame elements 14. The frame elements 14 extend radially in a swirling pattern from the compartment 40 to the fixture perimeter 10 and also rearward of the compartment 40 and fixture perimeter 10. Air gaps between the frame elements 14 reduce the overall mass of the light fixture and permit air flow around the compartment 40 to promote cooling and each of the frame elements 14 has edges that are beveled, rounded, or angled to minimize drag. The plurality of frame elements 14 are substantially ridge-like structures having an element width between about ½ of the length of the shortest element 14, and about 1/10 of the length the longest element 14, and preferably about ⅕th of the length of the shortest element 14 and about ⅖ths of the length the longest element 14, as measured from the compartment 40 to the fixture perimeter 10. Each of the plurality of elements 14 have lengths that vary depending on the location that each element 14 connects with or abuts to the compartment 40, the location that it connects with or abuts to the fixture perimeter 10, and the angle the element 14 makes with the side of the compartment 40 to which the element connects. Moreover, the longest frame element 14 is in the range of about 1.1 to 3.3 times longer than the shortest frame element 14 and preferably about 2.2 times longer than the shortest frame element 14. In an exemplary embodiment, the element width is about 0.064 inches, the shortest element length is about 0.375 inches, and the longest element length is about 0.825 inches.

The forward facing surface 22 of the transparent media 20 together with the forward or top edges of the frame elements 14 comprise a curved-convex uniform shape selected without limitation from domes of all types, including semi-spheroids, semi-ellipsoids, segmentals, polygonals, ovals, onions, and corbels. The preferred forward facing curved-convex uniform shape comprises a segmental or saucer dome having base diameter of between about 4.5 and 8.5 times and preferably about 6.5 times the height of the segmental dome. An exemplary embodiment includes a forward facing surface comprised of a segmental dome having a base-to-apex height of about 0.6 inches and a base diameter of 3.9 inches. The rearward or back edges of the frame elements 14 also comprise a curved-convex shape comprised of the rearward facing edges or surfaces of the frame elements 14 and the sub-perimeter 11, and selected without limitation from substantially dome-like structures of all types, including semi-spheroids, semi-ellipsoids, segmentals, polygonals, ovals, onions, and corbels. Again, the preferred rearward facing curved-convex uniform shape also comprises a segmental or saucer dome having base diameter of between about 2 and 4 times and preferably about 2.9 times the height of the segmental dome. An exemplary rearward facing curved convex shape comprises a substantially segmental dome having a base-to-apex height of about 1.3 inches and a base diameter of 3.75 inches.

The fixture perimeter 10 and sub-perimeter 11 are each selectable from the group of annular, elliptical, and rectangular perimeters as well as irregularly shaped and also uneven perimeters. The preferred perimeter 10 is annular or ring-like and has a width of between 1/10th and ⅙th but preferably about ⅛th of the diameter of the perimeter 10. An exemplary sub-perimeter 11 has a diameter of about 0.96 times the diameter of the perimeter.

Joining or coupling of the transparent media 20 to the fixture body 1 seals the compartment 40 and forms a complete curved convex surface comprised of the forward facing surface 22 of the transparent media 20 and the forward facing edges or portions of the frame elements 14. The compartment 40 is recessed from the forward facing edges 15 or portions of the frame elements 14 exposing interior edges 16 of the frame elements 14 which abut to sides of the transparent media 20. The transparent media 20 shape may comprise a smaller curved convex shape or segmental dome but a convex shape or segmental dome having a rectangular or square base (i.e. “a square dome”) is preferred. In such embodiments the transparent media base corners abut to and connect with the fixture perimeter 10 and the transparent media side edges 25 align with compartment wall edges 42 to seal the compartment 40. The forward surface 22 of the transparent media 20 also preferably includes a plurality of ridges 26 at or near the edges of the transparent media 20 and each of the ridges 26 on the transparent media 20 aligns with one of the plurality of frame elements 14 on the fixture. In the illustrated embodiment, the transparent media 20 is coupled to the fixture body 1 by mountings that extend beyond the compartment 40 and abut the fixture body perimeter 10 at positions between certain frame elements 14. The transparent media 20 couples to the fixture body 1 using fasteners selected without limitation from bolts, screws, clips or other fasteners equivalently capable of securing the transparent media 20. The coupling of the media 20 to the fixture seals the compartment 40 and secures the removable lens 30 from movement within the fixture.

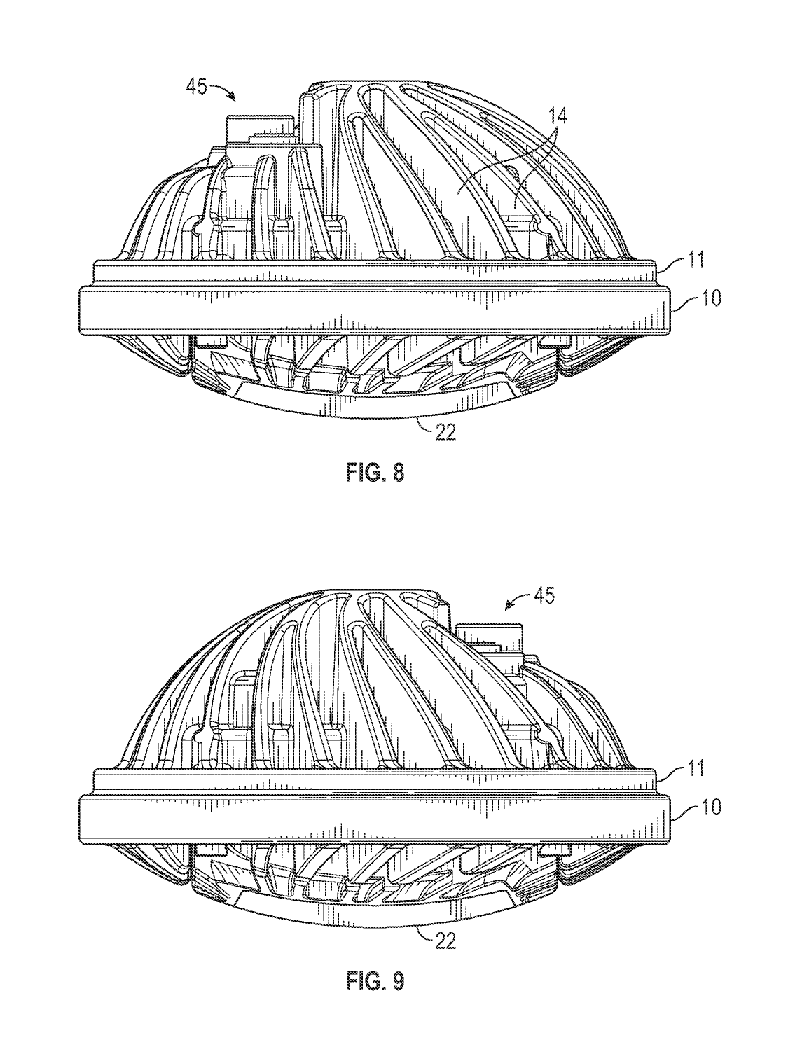

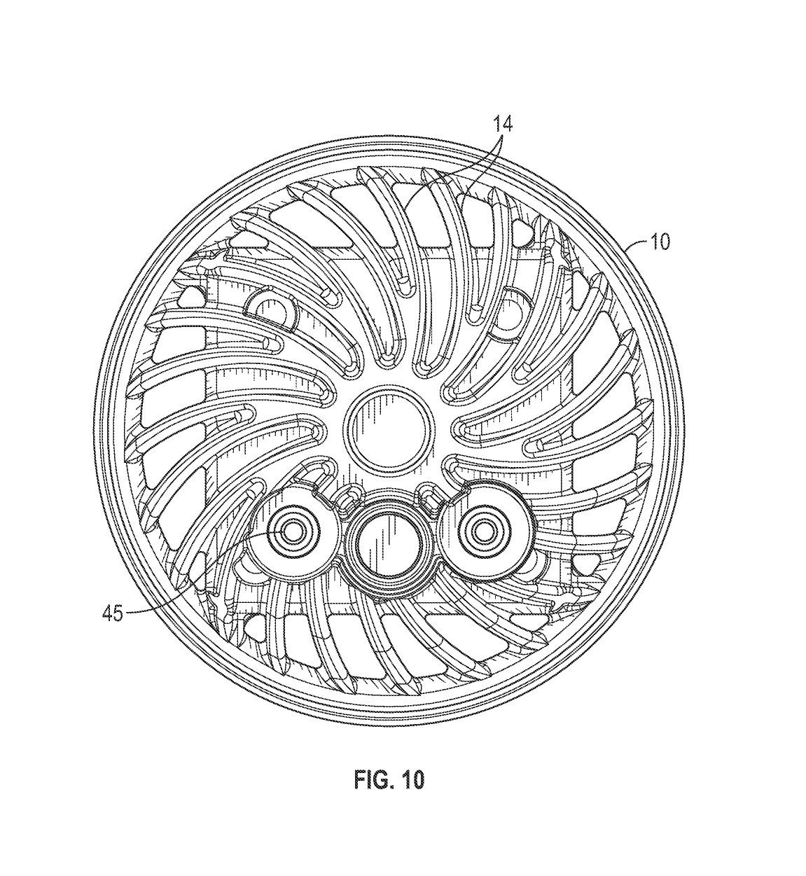

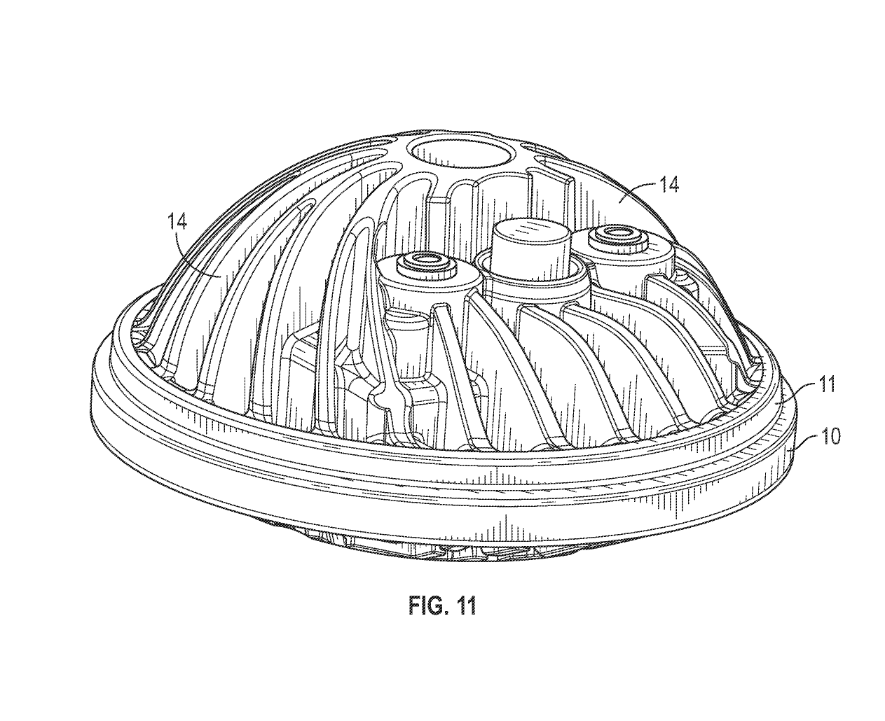

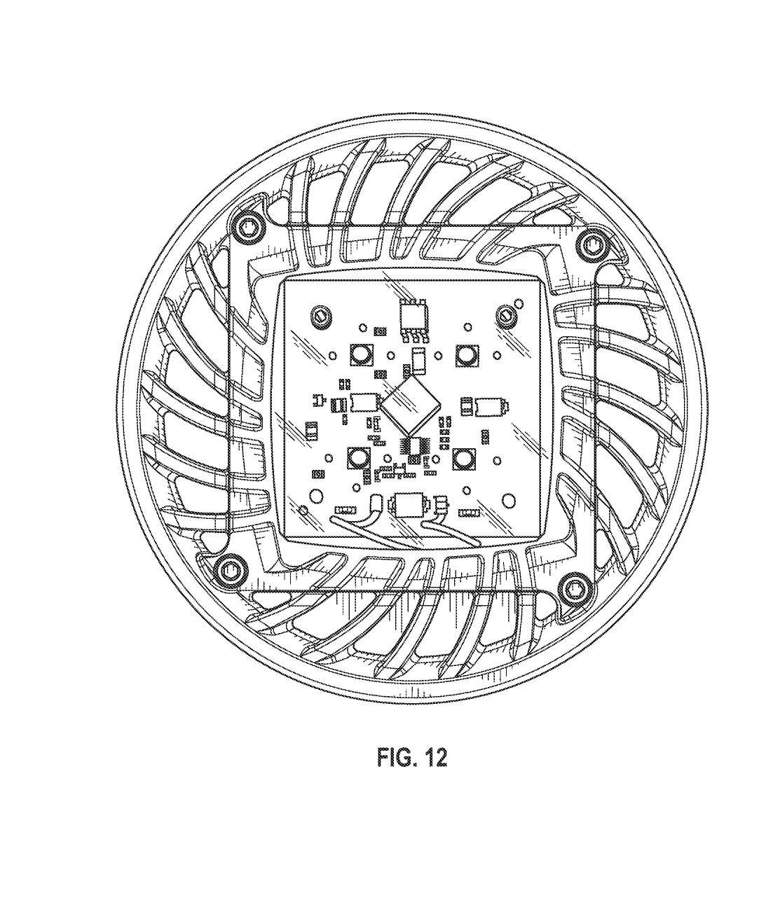

The surface area of forward surface 22 of the transparent media 20 relative to the forward facing portion of the fixture body 1 can be characterized by the relative amount of the two dimensional projections of the surface areas of each of the surfaces. As illustrated in FIG. 7, the two dimensional projections of the surface areas of each of the transparent media 20 and the forward facing portion of the fixture body 1 comprise a rectangle and circle, respectively, and the formulas for calculating the areas of each are length×width and A=πr², respectively. In segmental square dome embodiments having an unbroken or substantially solid forward facing surface (not illustrated), the ratio of the two dimensional projection of the forward facing surface area of the fixture body 1 relative to the two dimensional projection of the forward facing surface area of the transparent media 20 is between about 0.7 to 0.1.3 and preferably about 1.1. The use of frame elements 14 however, as opposed to the use of an unbroken or substantially solid forward facing surface, significantly reduces the area of the forward facing surface of the fixture body 1. In embodiments having a square dome shaped transparent media 20, and a forward facing surface of the fixture body 1 comprised of frame elements 14, the two dimensional projection of the forward facing surface area of the transparent media 20 is between about 4.4 and 8.1, and preferably 6.3, times the two dimensional projection of the forward facing surface area comprised of the forward facing edges of the fixture body 1.

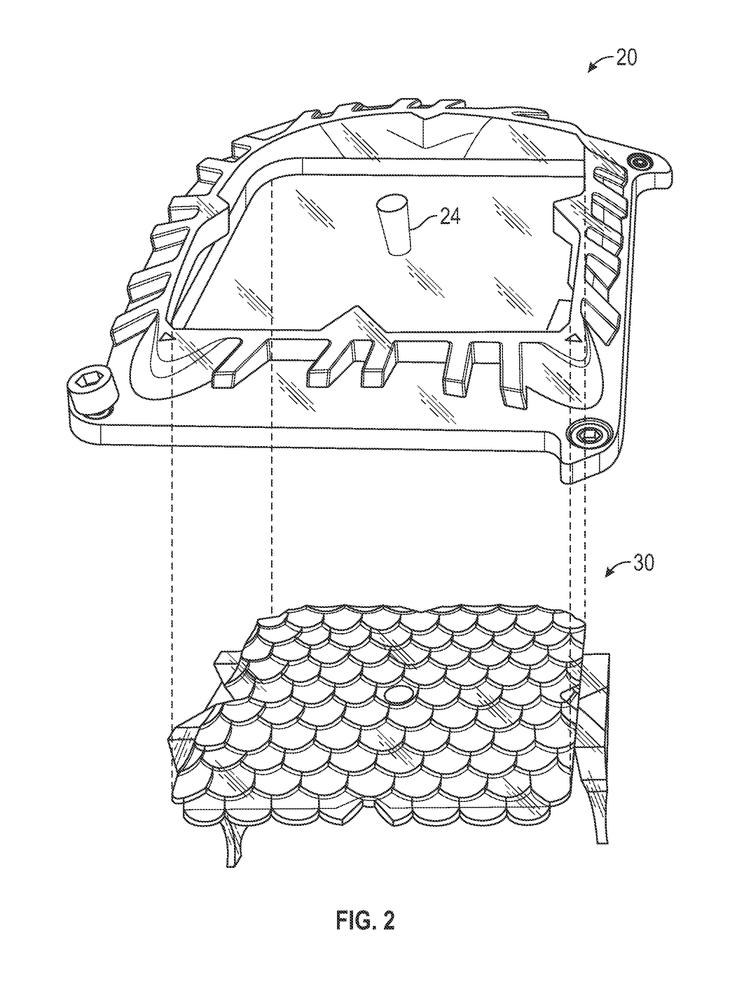

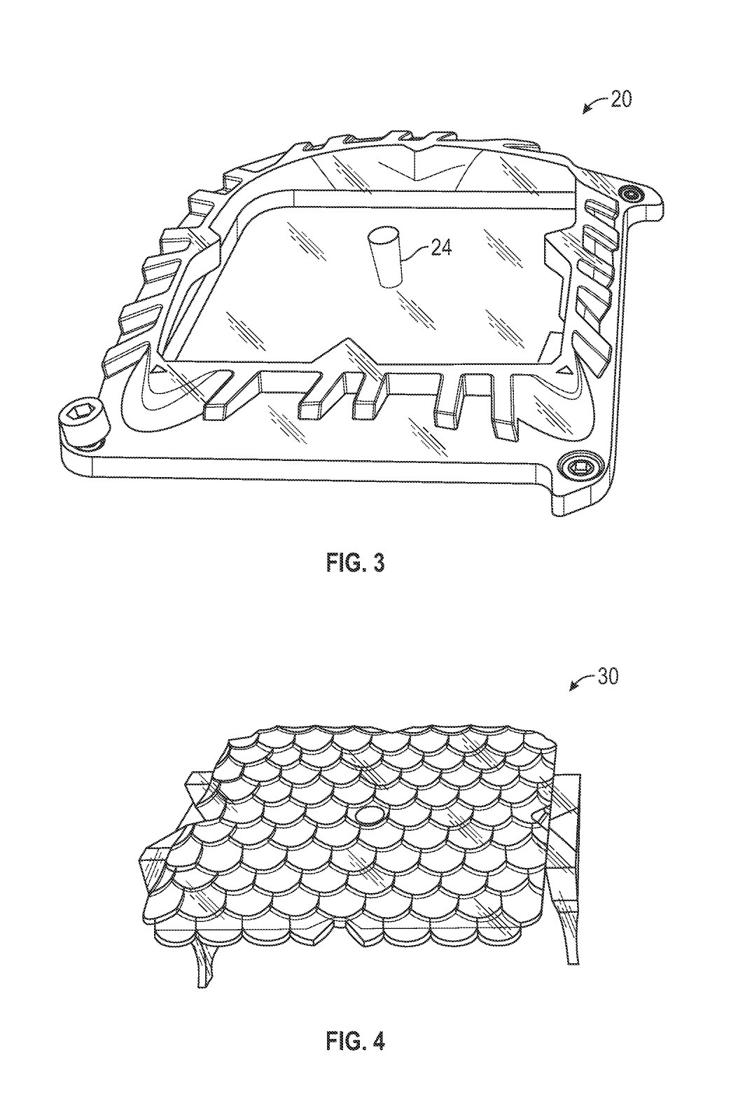

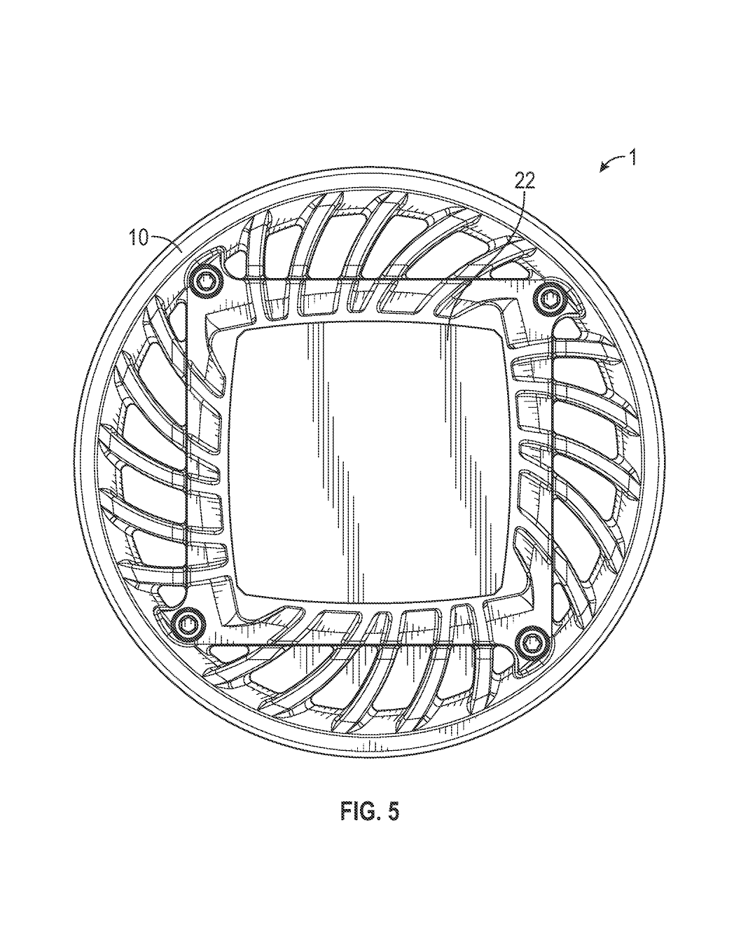

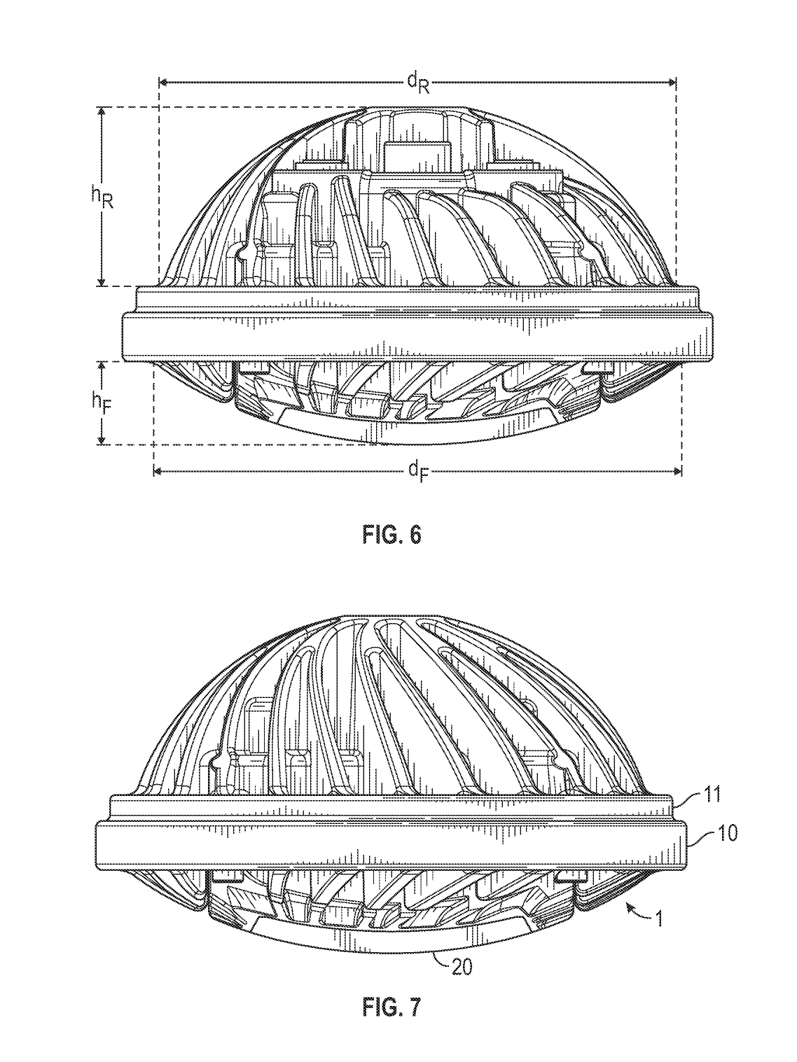

The transparent media 20 and removable lens 30 are comprised of a clear hard plastic such as Polycarbonate or Poly(methyl methacrylate), or equivalents and have a refractive index between about 1.2 and 1.8. The transparent media 20 and lens 30 include complementary structures that abut and contact the other and secure the lens 30 from movement relative to the media 20 and within the fixture. An exemplary structure comprises an edge or other impediment, such as a positive edge or a negative edge, that is received by or that receives its complementary edge on the insertable lenses 30. Exemplary structures having compliments suitable for use are selected without limitation from pins, bosses, and structural geometries such as without limitation rectangles, circles, and triangles, having one or more edges on the inner surface of transparent media 20 and a complementary edge on the removable lens 30. As one example, and as illustrated in FIG. 2, a positive edge 25 extending away from the inner surface of the transparent media 20 receives the outside or perimeter edge 35 of the removable lens 30, which lens 30 has edges 32 and dimensions that accommodate receipt into the positive perimeter edge 25. As another example, a wedge and its complementary shape extend from the inner surface of the transparent media 20 and are accessible on the forward or top surface of the lens 30 (or vice versa), respectively.

The lens 30 is received into a secured position adjacent at least the edges 25 of the transparent media 20 by one dimensional movement (see FIG. 2) and secured against the transparent media 20 by the features described above and by attaching the transparent media 20 to the fixture body 1. One or more standoffs 37 separates or distances the lens 30 away from the light source modules in the compartment 40 and also prevents movement in the reverse direction away from the transparent media 20. The standoffs 37 may brace against the printed circuit board or the compartment 40 interior and may be received in standoff notches in either the printed circuit board or fixture interior Further, the light source modules in the compartment 40 each include a reflector associated with a particular light source wherein the reflector has a distal end furthest from its associated light source. The lens 20 back surface is positioned adjacently and against the distal ends of the reflectors which alternatively prevent the lens 30 from rearward directional movement.

A second preferred structure for deterring movement of the lens 30 and comprises a positive edge on the inner surface of the transparent media 20 such as a boss 24, pin, post, or pillar extending substantially perpendicularly from the transparent media 20 inner surface. The preferred complementary edge on the lens 30 comprises a negative edge such as the edge surrounding an appropriately dimensioned aperture, notch, hole 36, oriented substantially perpendicular to the lens 30 surface and aligned with the boss 24. The lens 30 is received into a secured position against the transparent media 20 by one dimensional movement and secured against the transparent media 20 by attaching the transparent media 20 to the fixture frame 12.

An exemplary lens 30 is shown in FIG. 2 predominantly diffuses light emitted from the light source module(s) and includes diffusing lens surfaces, including without limitation, those selected from lenses comprising a plurality of convex offset rectangles (e.g. “pillowed”), opaque lenses, and honeycombed lenses. FIG. 2 shows a view of the honeycomb surfaced lens 30. A preferred diffusing lens 30 reduces the luminance directly in front of the lighting fixture at 10 meters by at least half the luminance directly in front of the lighting fixture at 10 meters with the diffusing lens removed. Or alternatively, the luminance at 10 meters in a direction parallel to the mechanical axis of the fixture with the removable lens 30 removed, is at least twice the luminance at 10 meters normal from or to the transparent media surface 22 with the insertable or removable lens 30 included

Another exemplary lens 30 (not shown) comprises a light directing lens that predominantly redirects, focuses, or collimates light from the light source module(s) 43. The light directing lens may be implemented by a collimating lens or equivalents thereof having a plurality of rows or columns of stepped or inclined lens surfaces or facets throughout the lens 30 to refract generated light incident upon the lens 30. The lens system described herein enables a lighting fixture having a selectable lighting characteristic or combination thereof. The lens 30 is inserted, removable, and/or orientable to enable selectable distribution or direction of light to accommodate various mounting alternatives. For example, inserting a light directing lens 30 designed to refract light at an angle downward from the angle of incidence facilitates mounting a lighting fixture to the cab or top of a vehicle. Alternatively, removal of the lens 30 enables light to be emitted substantially directly forward from the vehicle and facilitates mounting the lighting fixture to a vehicle grill. Inserting a diffusing lens 30 creates a wider distribution of light, which may be appropriate for both mounting options.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A light source comprising,
a fixture body having a compartment including at least one light source positioned to direct light from the compartment in a forward direction;
a transparent media that removably couples to the compartment; and
a removable lens positioned between the at least one light source and the transparent media, the removable lens deterred from movement by contact between the fixture body and the transparent media.

2. The light source in claim 1 further comprising,
a plurality of frame elements extending radially forward from a compartment wall with forward facing frame element edges framing a lower portion of a curved convex surface; and
the transparent media has a forward surface comprising an upper portion of the curved convex surface.

3. The light source in claim 2 wherein,
the transparent media forward surface has a plurality of ridges increasing in height proportionally to their distance from an apex of the curved convex surface.

4. The light source in claim 3 wherein,
each of the plurality of ridges aligns with one of the frame elements.

5. The light source in claim 2 wherein,
the frame elements swirl radially from the compartment wall.

6. The light source in claim 2 wherein,
the frame elements join to a perimeter of the fixture body selected from annular, elliptical, and rectangular perimeters, and oriented about a mechanical axis oriented parallel to the forward direction.

7. The light source in claim 2 wherein,
the curved convex surface has a base diameter of between about 4.5 and 8.5 times the height of the curved convex surface.

8. The light source in claim 2 wherein,
the two dimensional projection of the surface area of the transparent media is between about 4.4 and 8.1 times the surface area comprised of the two dimensional projection of the forward facing surfaces of the lower portion of the curved convex surface.

9. The light source in claim 2 wherein,
the plurality of frame elements also extend rearward radially from the compartment wall.

10. The light source in claim 9 wherein,
the plurality of frame elements also extending rearward have rearward facing edges framing a rearward facing substantially curved convex surface.

11. The light source in claim 9 wherein,
the rearward facing substantially curved convex surface has a base diameter of between about 2 and 4 times the height of the curved convex surface.

12. The light source in claim 1 further comprising,
a transparent media perimeter inner surface having an edge at a transparent media perimeter abutting the removable lens that deters movement of the removable lens relative to the transparent media.

13. The light source in claim 1 wherein,
the removable lens is selected from group of diffusing lenses and light collimating lenses.

14. The light source in claim 13 further comprising,
a plurality of reflectors, each reflector positioned adjacent one of the plurality of light sources to reflect light from the light source in a substantially forward direction, the reflectors each having a distal end furthest from the light source, and
wherein the removable lens is positioned adjacent the distal ends of the reflectors and substantially perpendicularly to the forward direction.

15. A light source comprising,
a fixture body having a recessed compartment and a plurality of frame ridges extending radially forward from the compartment with forward facing frame ridge edges framing a lower portion of a segmental dome; and
a transparent media that couples to the compartment, the transparent media having a forward surface comprising an upper portion of the segmental dome.

16. The light source in claim 15 further comprising,
a removable lens positioned between the compartment and the transparent media and deterred from movement by contact between the fixture body and the transparent media.

17. The light source in claim 15 wherein,
the plurality of frame ridges also extend rearward radially from the recessed compartment and have rearward facing edges framing a rearward facing segmental dome.

18. The light source in claim 17 wherein,
the rearward facing segmental dome has a base diameter of between about 2 and 4 times the height of the dome.

19. The light source in claim 15 wherein,
a transparent media further has a back surface and the removable lens contacts the back surface to deter movement of the removable lens relative to the transparent media.

20. The light source in claim 15 wherein,
the removable lens has at least one standoff that extends into the compartment.

21. A method of changing the lighting characteristics of a lighting fixture that has a plurality of light source modules, the method comprising:
inserting at least one lens selected from the group consisting of collimating or diffusing lenses between a transparent media and a compartment sealed by the transparent media; and
attaching the transparent media to the lighting enclosure.
